(19) United States
(12) Patent Application Publication
(10) Pub. No.: US 2026/0169366 A1
(43) Pub. Date: Jun. 18, 2026

(54) Infotainment apparatus for vehicle and method therefor

(71) Applicant: HYUNDAI MOBIS CO., LTD., Seoul (KR)

(72) Inventors: Ho Won SON, Yongin-si (KR); Cheon Seop SHIN, Yongin-si (KR)

(73) Assignee: HYUNDAI MOBIS CO., LTD., Seoul (KR)

(21) Appl. No.: 19/273,880

(22) Filed: Jul. 18, 2025

(30) Foreign Application Priority Data
Dec. 18, 2024 (KR) 10-2024-0189690

(51) Int. Cl. G03B 21/58; B60R 11/00; B60R 11/02

(52) U.S. Cl. CPC G03B 21/58; B60R 2011/0028; B60R 2011/0092; B60R 11/0235; B60R 2011/0276

(57) ABSTRACT

According to an embodiment of the disclosure, an infotainment apparatus is provided, including: an inner cover provided in a roof of a vehicle; a projection screen disposed at a bottom of the inner cover and exposed from the roof such that an image or video output from a projector provided in the vehicle is irradiated thereon; an outer cover to which an edge of the projection screen is pivotally fixed, wherein the projection screen includes a theater screen in which the image or video irradiated from the projector is irradiated, the theater screen including a first irradiation surface having a predetermined curved surface and a first screen frame; and an info screen stored into or exposed from the first screen frame.

### CROSS-REFERENCE TO RELATED APPLICATIONS

This application claims the benefit of priority to Korean Patent Application No. 10-2024-0189690 filed in the Korean Intellectual Property Office on Dec. 18, 2024, the entire contents of which are incorporated herein by reference.

### TECHNICAL FIELD

The disclosure relates to an infotainment apparatus for a vehicle and a method therefor.

### BACKGROUND ART

The content described in this section merely provides background information for the disclosure and does not constitute the prior art.

A display device capable of providing various information may be installed in an interior of the vehicle, for example a centerfascia, a dashboard or a head lining. Such a display device may provide various entertainment content as well as various information regarding the vehicle. For example, the display device may play a video, receive a terrestrial broadcast or a satellite broadcast and display the video on a screen, provide information for user convenience such as a vehicle state, weather, and news, and perform a role of navigation. The display device may be configured as a large-screen.

Once mounted in a vehicle, conventional display devices must be fixed in shape and position. In particular, when a large-screen display device is mounted on a headlining of the vehicle, there is a problem that a large amount of space is occupied inside the vehicle.

### DISCLOSURE OF INVENTION

### Technical Problem

Accordingly, the disclosure is directed to solve these problems, and has a main purpose of providing a large-screen display that is exposed or stored inside a vehicle.

In addition, the disclosure has a main purpose of increasing the degree of integration of an in-vehicle infotainment apparatus by superimposing displays of different sizes on each other.

In addition, the disclosure has a main purpose of selectively driving the displays of different sizes to provide visual information to a user, based on a driving request signal of the user.

An aspect of the disclosure is not limited to problems described above, and other problems not explicitly mentioned will be clearly understood by those skilled in the art based on the following description.

### Solution to Problem

According to an embodiment of the disclosure, an infotainment apparatus is provided, including: an inner cover provided in a roof of a vehicle; a projection screen disposed at a bottom of the inner cover and exposed from the roof such that an image or video output from a projector provided in the vehicle is irradiated thereon; an outer cover to which an edge of the projection screen is pivotally fixed, wherein the projection screen includes a theater screen in which the image or video irradiated from the projector is irradiated, the theater screen including a first irradiation surface having a predetermined curved surface and a first screen frame; and an info screen stored into or exposed from the first screen frame.

### Effects of Disclosure

According to an embodiment, an infotainment apparatus according to the disclosure has an effect of providing a large-screen display that is exposed or stored inside a vehicle.

In addition, according to an embodiment, the infotainment apparatus according to the disclosure is configured by superimposing displays of different sizes on each other, which has an effect of increasing the degree of integration in the vehicle.

In addition, according to an embodiment, the infotainment apparatus according to the disclosure has an effect of effectively providing visual information to a user by selectively driving displays of different sizes based on a driving request signal of the user.

### BRIEF DESCRIPTION OF DRAWINGS

FIG. 1 is a diagram illustrating an infotainment apparatus disposed inside a roof of a vehicle according to an embodiment of the disclosure.

FIG. 2 is a perspective view illustrating an infotainment apparatus according to an embodiment of the disclosure.

FIG. 3 is an exploded perspective view illustrating an infotainment apparatus according to an embodiment of the disclosure.

FIG. 4 is an operational state diagram illustrating driving of a theater screen according to an embodiment of the disclosure.

FIG. 5 is a cross-sectional view of an infotainment apparatus according to an embodiment of the disclosure.

### DETAILED DESCRIPTION FOR CARRYING OUT THE INVENTION

Hereinafter, some embodiments of the disclosure will be described in detail with reference to illustrative drawings. It should be noted that, in adding an reference numerals to the components in each figure, the same components have the same numerals as much as possible even if they are indicated in other figures. In addition, in the description of the disclosure, when it is determined that a specific description of a related known configuration or function may obscure the gist of the disclosure, a detailed description thereof will be omitted.

In describing the components of the embodiments according to the disclosure, reference numerals such as first, second, i), ii), a), and b) may be used. These reference numerals are merely used to distinguish the components from other components, and the nature, sequence, order, and the like of the components are not limited by the reference numerals. In the specification, when a portion is referred to as “comprising” or “including” a component, this means that other components may be further included instead of excluding other components unless explicitly stated to the contrary.

When a component is described as being “connected”, “coupled” or “joined” to another component, it should be understood that the component may be directly connected or joined to the other component, but that another component may be “connected”, “coupled” or “joined” between each component.

The terms “portion”, “module”, and the like described in the specification mean a unit that processes at least one function or operation, and may be implemented by hardware or software, or a combination of hardware and software.

It should be noted that, unless otherwise stated, the description of one embodiment may be applied to other embodiments as well.

The description of the disclosure, disclosed with reference to the accompanying drawings, is intended to describe exemplary embodiments of the disclosure and is not intended to represent the only embodiments in which the disclosure may be practiced.

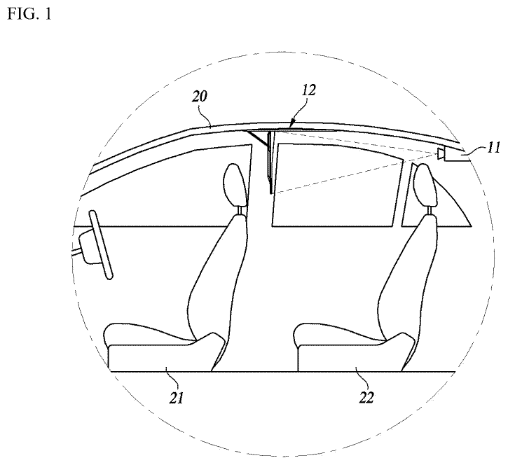

FIG. 1 is a diagram illustrating an infotainment apparatus disposed inside a roof of a vehicle according to an embodiment of the disclosure.

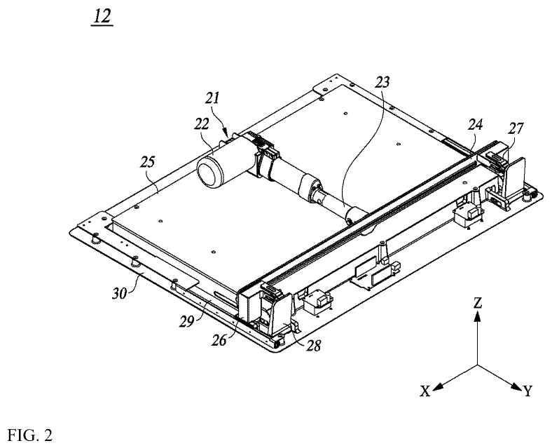

FIG. 2 is a perspective view illustrating an infotainment apparatus according to an embodiment of the disclosure.

Referring to FIG. 1 and FIG. 2, the infotainment apparatus 12 according to the disclosure may be embedded in a roof 20 of the vehicle. The vehicle according to the disclosure may be configured to include a predetermined space in the roof 20. The infotainment apparatus 12 may be coupled using a bolt, a nut, or the like in order to be fixed to a space in the roof 20.

The infotainment apparatus 12 according to the disclosure includes some or all of an inner cover 25, a projection screen 31, and an outer cover 30.

The inner cover 25 according to the disclosure may be provided in a predetermined space in the roof 20 of the vehicle. Although not shown in FIG. 1 and FIG. 2, the inner cover 25 may be coupled with separate bracket configurations for being fixed in the roof 20.

The infotainment apparatus 12 according to the disclosure may be irradiated with an image or video output from a projector 11. The infotainment apparatus 12 irradiated with the output image or video may visually provide various information such as driving information and entertainment of the vehicle to the user in the vehicle.

The projector 11 according to the disclosure may be mounted or attached to any one place of the interiors of the vehicle. With reference to the arranged position of the projector 11 shown in FIG. 1, the projector 11 is preferably arranged to irradiate light toward the front, which is the traveling direction of the vehicle. However, the disclosure is not limited thereto, and the disposed position of the projector 11 may also be changed according to the disposed state of the infotainment apparatus 12.

The infotainment apparatus 12 may be disposed at any one place in front of the projector 11 on the roof 20. Specifically, the infotainment apparatus 12 may be driven to be exposed from the roof 20 based on the driving request signal from a state of being embedded in the roof 20.

The infotainment apparatus 12 according to the disclosure may be disposed between the front seat 13 and the rear seat 14 of the vehicle on the roof 20. However, the in-vehicle position of the infotainment apparatus 12 is not limited thereto. Based on the parked or stopped state of the vehicle, the infotainment apparatus 12 may be exposed from the roof 20 at a position corresponding to the windshield of the vehicle. In this case, all of the users seated in the front seat 13 and the rear seat 14 of the vehicle may view the image or video irradiated on the infotainment apparatus 12.

The projection screen 31 according to the disclosure is disposed at the bottom of the inner cover 25. The projection screen 31 is driven to be exposed from the roof 20 so that the image or video output from the projector 11 provided in the vehicle is irradiated thereon.

The projection screen 31 according to the disclosure may be exposed from or stored into an inner space formed by the inner cover 25 and the outer cover 30 to be described later, based on a driving force of the first driving module 21 disposed on the upper portion of the inner cover 25. In some embodiments, the first driving module 21 may be referred to as a first driving controller.

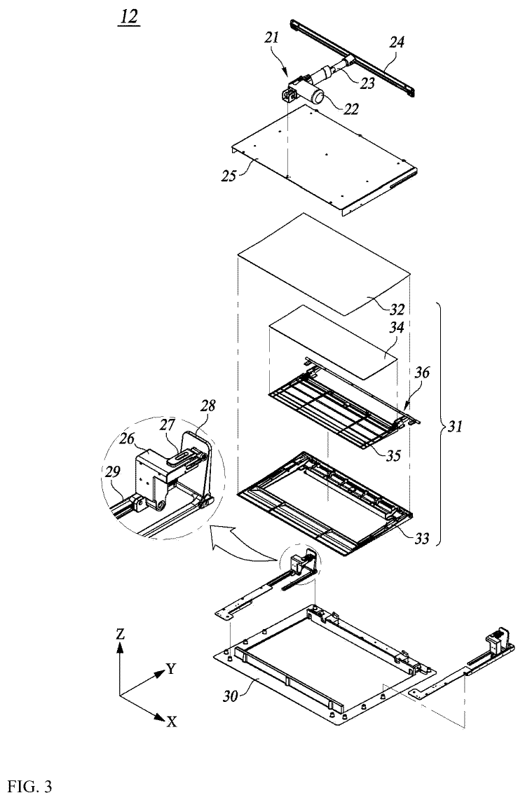

A specific configuration and driving method of the projection screen 31 will be described later in FIG. 3.

The first driving module 21 according to the disclosure includes a linear motor 22, rail members, link portions 26, a driving force transmission member 24, and a rotation assisting portion 28.

The linear motor 22 according to the disclosure is fixed to any one place of the upper surfaces of the inner cover 25 using a bracket, and is configured to generate a driving force to advance or reverse the driving shaft 23.

The driving shaft 23 according to the disclosure may be disposed on the upper surface of the inner cover 25 in the same direction as the traveling direction of the vehicle. Based on the drive of the linear motor 22, the driving shaft 23 moves forward in the Y-axis direction or backward in the (−)Y-axis direction in FIG. 2. The projection screen 31 may be exposed or stored by this advancing or reversing driving shaft 23. Here, the projection screen 31 being exposed or stored means that the projection screen 31 is exposed from or stored into the inner space formed by coupling the outer cover 30 and the inner cover 25, toward an inner space corresponding to a head room in the vehicle.

The rail members according to the disclosure are respectively disposed on both sides of the inner cover 25 in a direction parallel to the driving shaft 23. The rail member guides the movement of the link portions 26 in the Y-axis direction or the (−)Y-axis direction.

The rail members may be fixed to the upper surface of the outer cover 30. A partial region of the rail members in the (−)Y-axis direction is formed in a predetermined plate shape so as to be coupled to a part of the outer cover 30, and a plurality of holes (not shown) may be formed in the upper direction.

The link portions 26 according to the disclosure are respectively connected to rail members configured on both sides of the inner cover 25. The link portions 26 may move forward in the Y-axis direction or backward in the (−)Y-axis direction along the rail members. The link portions 26 move on the rail members based on the movement of the driving force transmission member 24 moving forward or backward.

The driving force transmission member 24 according to the disclosure is extendedly coupled to the other end of the driving shaft 23 of the linear motor 22.

The driving force transmission member 24 is disposed and coupled in a direction perpendicular to the driving shaft 23 at the upper portion of the inner cover 25, and has a predetermined length for being connected to the link portions 26 disposed at positions separated from each other in the X-axis direction. The driving force transmission member 24 is configured to advance or reverse the link portions 26 based on the rotational direction of the linear motor 22 to expose or store the projection screen 31.

A roller member 27 according to the disclosure may be coupled to the upper portion of each of the link portions 26. The roller portion may be coupled in the Y-axis direction on the upper portion of each of the link portions 26.

The roller member 27 may transmit force to the rotation assisting portion 28, which will be described later, based on forward movement of the link portions 26 in a Y-axis direction. A wheel (not shown) or a roller (not shown) may be coupled to the other end of the roller member 27 in the Y-axis direction.

One end of the rotation assisting portion 28 according to the disclosure is connected to the projection screen 31. The rotation assisting portion 28 is configured to store the projection screen 31 according to the driving of the link portions 26.

The rotation assisting portion 28 may be rotated in the first rotational direction to guide the projection screen 31. Here, the first rotational direction may mean a clockwise direction with respect to the X-axis. In addition, the rotation assisting portion 28 may rotate in the second rotational direction by a force applied according to the driving of the roller member 27 coupled to the link portions 26, and store the projection screen 31. Here, the second rotational direction means a direction opposite to the first rotational direction.

The outer cover 30 according to the disclosure may be disposed to be exposed to the user from the roof 20 of the vehicle. Therefore, the outer cover 30 may be configured such that its material, color, and the like correspond to those of the roof 20 so as to form a sense of unity with the roof 20. For example, the outer cover 30 may be made of the same metal material as the roof 20, or may directly implement the paint color and texture of the roof 20 to provide uniformity of appearance. In addition, the outer cover 30 may be subjected to a curved surface treatment so as to naturally connect with the roof 20.

FIG. 3 is an exploded perspective view illustrating an infotainment apparatus according to an embodiment of the disclosure.

Referring to FIG. 3, the infotainment apparatus 12 according to an embodiment of the disclosure may include the projection screen 31.

The projection screen 31 may be disposed in the inner space formed by the inner cover 25 and the outer cover 30.

The projection screen 31 according to the disclosure includes the theater screens 32, 33 and the info screens 34, 35.

The projection screen 31 according to the disclosure is configured such that the info screens 34, 35 are superimposed on the theater screens 32, 33. Through a superimposed structure of the info screens 34, 35 and the theater screens 32, 33, the projection screen 31 may increase the degree of integration in the vehicle and improve the emotional quality in the vehicle.

The theater screens 32, 33 according to the disclosure are exposed from or stored into the inner space formed by the inner cover 25 and the outer cover 30, based on a driving force of the first driving module 21 disposed on the upper portion of the inner cover 25. Here, the first driving module 21 according to the disclosure is fixed to any one place of the upper surfaces of the inner cover 25.

The theater screens 32, 33 according to the disclosure include a first irradiation surface 32 and a first screen frame 33.

The first irradiation surface 32 is coupled to a curved surface of the first screen frame 33. However, the disclosure is not limited thereto, and the first irradiation surface 32 may be configured in the form of a film and attached or adhered to the first screen frame 33.

The first screen frame 33 includes an opening hole (not shown) for the info screens 34, 35 to be superimposed. The first screen frame 33 may include an internal space in which a second driving module 36, which will be described later, configured for driving the info screens 34, 35, may be disposed. In some embodiments, the second driving module 36 may be referred to as a second driving controller.

The first irradiation surface 32 according to the disclosure is directly irradiated with the image or video irradiated from the projector 11, after the theater screens 32, 33 are exposed from the inner space formed by the inner cover 25 and the outer cover 30.

The info screens 34, 35 according to the disclosure may be exposed from or stored into a space inside the vehicle from the theater screens 32, 33 based on the driving force of the second driving module 36. The second driving module 36 according to the disclosure includes a DC motor (not shown) and a gearbox (not shown). The DC motor and gearbox may be coupled to the interior of the first screen frame 33. The second driving module 36 may expose the info screens 34, 35 from the theater screens 32, 33 by transmitting rotational force of the DC motor through the gearbox. The second driving module 36 may store the info screens 34, 35 into the theater screens 32, 33 by transmitting rotational force of the DC motor through the gearbox.

The info screens 34, 35 according to the disclosure are preferably formed with the same curvature radius as the theater screens 32, 33 so as to be stored in the theater screens 32, 33 to form a sense of unity.

The info screens 34, 35 according to the disclosure include a second irradiation surface 34 and a second screen frame 35.

The second irradiation surface 34 may be coupled to a curved surface of the second screen frame 35. However, the disclosure is not limited thereto, and the second irradiation surface 34 may be configured in the form of a film and attached or adhered to the second screen frame 35.

The second irradiation surface 34 according to the disclosure is irradiated with the image or video irradiated from the projector 11 after the info screens 34, 35 are exposed from the theater screens 32, 33.

The first screen frame 33 and the second screen frame 35 according to the disclosure are formed to have a curvature of, for example, 1,600 R to 3,000 R. Here, the unit R means a radius of curvature, and indicates the degree of curvature of the first screen frame 33 and the second screen frame 35 according to the disclosure.

The first screen frame 33 and the second screen frame 35 are configured to provide optimal visibility to the user through a predetermined curvature when an image or video irradiated from the projector 11 is irradiated on the first irradiation surface 32 or the second irradiation surface 34.

The first screen frame 33 and the second screen frame 35 according to the disclosure may be configured based on a metal screen structure. Specifically, the first screen frame 33 and the second screen frame 35 may be formed based on an aluminum material.

Each of the first screen frame 33 and the second screen frame 35 according to the disclosure includes a second reflective layer and a base layer.

The second reflective layer according to the disclosure may be subjected to a black surface treatment so as to adjust a contrast ratio of the image or video irradiated on the first irradiation surface 32 or the second irradiation surface 34 and reduce interference of an external light source. The second reflective layer subjected to the black surface treatment may have, for example, a transmittance of 50%. However, the black surface treatment of the second reflective layer may be omitted.

The base layer according to the disclosure provides the curved surface support strength of the first screen frame 33 and the second screen frame 35. In addition, it may be configured to prevent a hot-spot phenomenon that may occur in a curved screen of a projection type.

The first irradiation surface 32 and the second irradiation surface 34 according to the disclosure include a surface layer, a diffusion layer, and a first reflection layer.

The surface layer according to the disclosure is formed to adjust the resolution of the image or video irradiated from the projector 11. The surface layer may be configured to suppress unnecessary reflection by the external light source to maintain a clear image, and the material of the surface layer may be designed from a material having excellent optical transparency and durability. In particular, anti-reflection and anti-scratch coatings may be applied to provide a high-quality screen stably for a long period of time.

The diffusion layer according to the disclosure improves the viewing angle of the projection screen 31 and adjusts the brightness of the image or video irradiated thereon. The diffusion layer may adjust the brightness of the image or video irradiated from the projector 11 to optimize the quality of the video. Specifically, the diffusion layer maintains a color balance of the irradiated light and minimizes color distortion, thereby optimizing the quality of the video. This is implemented by utilizing an optical material containing fine diffusing particles, and may optimize the contrast ratio of high dynamic range (HDR) content.

The first reflective layer according to the disclosure is configured to reflect light dispersed from the diffusion layer to adjust brightness. The first reflective layer is configured to have a brightness of, for example, about 3 to 3.5 Gain. Here, the unit Gain is a value indicating the amount of light reflected in a specific direction. The Gain may be determined by the material of the first reflective layer, the surface finish, or the like. The first reflective layer may be configured in the form of a high reflectivity metal or polymer based reflective film. A multilayer reflective structure may be applied to the first reflective layer to increase the reflection efficiency. In addition, the reflective layer includes heat dissipation characteristics to prevent thermal deformation during long-term use, and the reflectance and Gain value may be adjusted according to the use environment.

Although not shown in FIG. 1 and FIG. 2, the infotainment apparatus 12 according to the disclosure includes a control unit.

In some embodiments, the control unit may be referred to as a controller. According to an exemplary embodiment of the present disclosure, the control unit may include a processor (e.g., computer, microprocessor, CPU, ASIC, circuitry, logic circuits, etc.) and an associated non-transitory memory storing software instructions which, when executed by the processor, provides the functionalities of the control unit. Herein, the memory and the processor may be implemented as separate semiconductor circuits. Alternatively, the memory and the processor may be implemented as a single integrated semiconductor circuit. The processor may embody one or more processor(s).

The control unit controls a plurality of operation modes to be driven based on the driving request signal of the user. For example, the plurality of operation modes include a first operation mode and a second operation mode.

The first operation mode refers to an operation mode in which the theater screens 32, 33 are driven to provide the in-vehicle user with a large screen-based driving information. In addition, the second operation mode may operate to drive the info screens 34, 35 to provide the driving information of the vehicle to the user in the vehicle. Here, the driving information of the vehicle may include a speed of the vehicle, an engine state, a remaining fuel amount, a battery state, navigation route information, surrounding vehicle and road environment information, and the like.

The driving request signal received by the control unit from the user may be generated in the form of any one of a smart pointer remote control provided in the vehicle, a smartphone control app, a voice control, and a hand gesture.

The control unit may control driving of the linear motor 22 of the first driving module 21 and the DC motor of the second driving module 36 to be described later. Therefore, based on the driving request signal received from the user, the control unit may selectively control the driving of the theater screens 32, 33 or the info screens 34, 35.

FIG. 4 is an operational state diagram illustrating driving of a theater screen according to an embodiment of the disclosure.

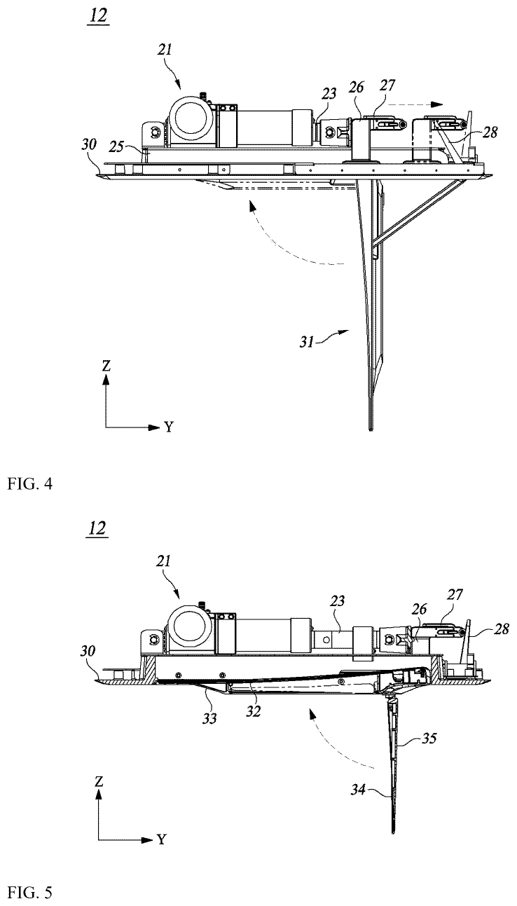

FIG. 5 is a cross-sectional view of an infotainment apparatus according to an embodiment of the disclosure.

Referring to FIG. 2 to FIG. 5, the theater screens 32, 33 according to the disclosure may be stored into the inner space formed by the inner cover 25 and the outer cover 30. In this case, the first driving module 21 advances the driving force transmission member 24 connected to the driving shaft 23 in the Y-axis direction. As the driving force transmission member 24 advances in the Y-axis direction, the link portions 26 are moved in the Y-axial direction. The roller member 27 coupled to the link portions 26 presses the rotation assisting portion 28 rotated based on the exposed state of the theater screens 32, 33 in the Y-axis direction. The rotation assisting portion 28 may rotate with respect to a pivot point fixed on the outer cover 30 and store the theater screens 32, 33 into the inner space.

The projection screen 31 according to the disclosure is formed to have a predetermined radius of curvature when viewed in the X-axis direction. Specifically, the first irradiation surface 32 coupled with the first screen frame 33 may be configured to have a predetermined radius of curvature. The second irradiation surface 34 of the info screen 34, 35 superimposed inside the first screen frame 33 will also be configured to have a radius of curvature corresponding to the first irradiation surface 32.

The info screens 34, 35 according to the disclosure may be exposed from the theater screens 32, 33 based on the driving force of the second driving module 36. The second driving module 36 may rotate relative to the pivot point fixed to the first screen frame 33. The second driving module 36 may expose the info screens 34, 35 from the theater screens 32, 33. The second driving module 36 may store the info screens 34, 35 into the theater screens 32, 33.

The above description is merely illustrative of the technical idea of the present embodiment, and various modifications and variations will be possible to those skilled in the art without departing from the essential characteristics of the present embodiment. Therefore, the present embodiments are not intended to limit but to explain the technical idea of the present embodiment, and the scope of the technical idea of this embodiment is not limited by this embodiment. The protection scope of the present embodiment should be interpreted by the following claims, and all technical ideas falling within the scope equivalent thereto should be interpreted as being included in the scope of rights of the present embodiment.

1. An infotainment apparatus comprising:
an inner cover provided in a roof of a vehicle;
a projection screen disposed at a bottom of the inner cover and exposed from the roof such that an image or video output from a projector provided in the vehicle is irradiated thereon;
an outer cover to which an edge of the projection screen is pivotally fixed,
wherein the projection screen comprises:
a theater screen in which the image or video irradiated from the projector is irradiated, the theater screen comprising a first irradiation surface having a predetermined curved surface and a first screen frame; and
an info screen stored into or exposed from the first screen frame.

2. The infotainment apparatus of claim 1, wherein
the theater screen is configured to be exposed from or stored into an inner space formed by the inner cover and the outer cover based on driving force of a first driving controller disposed on the upper portion of the inner cover.

3. The infotainment apparatus of claim 2, wherein:
the first driving controller comprises:
a linear motor that is fixed to any one place of upper surfaces of the inner cover and configured to generate a driving force to advance or reverse the driving shaft;
rail members respectively disposed on both sides of the inner cover in a direction parallel to the driving shaft and partially coupled to the outer cover;
link portions respectively connected to the rail members and configured to move along the rail members;
a driving force transmission member extendedly coupled to the other end of the driving shaft and configured to move the link portions based on a rotational direction of the linear motor to expose or store the projection screen; and
a rotation assisting portion having one end connected to the projection screen and configured to store the projection screen in accordance with driving of the link portion.

4. The infotainment apparatus of claim 3, wherein
the rotation assisting portion is configured to rotate in a first rotational direction to support the exposed state of the theater screen, or rotate in a second rotational direction opposite to the first rotational direction by a force applied according to driving of a roller member coupled to the link portion to store the theater screen.

5. The infotainment apparatus of claim 1, wherein
the info screen comprises:
a second irradiation surface formed based on a curved surface corresponding to the first irradiation surface and on which the image or video output from the projector is irradiated and;
a second screen frame coupled with the second irradiation surface; and
a second driving controller disposed inside the first screen frame and configured to expose or store the info screen from or into the theater screen based on driving forces of motors symmetrically disposed at both ends of the first screen frame.

6. The infotainment apparatus of claim 5, wherein
each of the first screen frame and the second screen frame is configured based on a metal screen structure made of aluminum material.

7. The infotainment apparatus of claim 5, wherein
each of the first irradiation surface and the second irradiation surface comprises:
a surface layer formed to adjust a resolution of an image or video irradiated from the projector;
a diffusion layer configured to improve a viewing angle and optimize image quality by adjusting brightness of the irradiated image or video; and
a first reflective layer configured to reflect light diffused from the diffusion layer to adjust brightness.

8. The infotainment apparatus of claim 5, wherein
each of the first screen frame and the second screen frame comprises:
a second reflective layer that is subjected to a black surface treatment so as to adjust a contrast ratio of the image or video to be irradiated and reduce interference of an external light source; and
a base layer configured to provide a curved surface support strength and prevent a hot-spot phenomenon.

9. The infotainment apparatus of claim 1, wherein
the projection screen comprises:
a plurality of operation modes for driving based on a driving request signal of a user, the plurality of operation mode comprising:
a first operation mode configured to drive the theater screen to provide a large screen-based image and video information to a user inside the vehicle; and
a second operation mode configured to drive the info screen to provide driving information of the vehicle to the user inside the vehicle.

10. The infotainment apparatus of claim 9, wherein
the driving request signal is generated by at least one of a smart pointer remote control, a smartphone control app, a voice control, or a hand gesture provided in the vehicle.
